(19) United States
(12) Patent Application Publication
(10) Pub. No.: US 2024/0388110 A1
(43) Pub. Date: Nov. 21, 2024

(54) MULTI-VOLTAGE SOURCE TRIGGER SWITCH

(71) Applicant: MILWAUKEE ELECTRIC TOOL CORPORATION, Brookfield, WI (US)

(72) Inventor: Peter J. Wawer, Wauwatosa, WI (US)

(21) Appl. No.: 18/693,207

(22) PCT Filed: Sep. 27, 2022
(86) PCT No.: PCT/US22/44819

§ 371 Date: Mar. 19, 2024

Related U.S. Application Data
(60) Provisional application No. 63/248,702, filed on Sep. 27, 2021.

(51) Int. Cl. H02J 7/00

(52) U.S. Cl. CPC H02J 7/0063; H02J 7/0025; H02J 7/0032; H02J 2310/22

(57) ABSTRACT

A power management system that includes a battery pack powered tool, one or more battery packs coupled to the battery pack powered tool, a first voltage regulator providing a first output voltage, a second voltage regulator providing a second output voltage, and a trigger configured to receive the first output voltage and the second output voltage. The system also includes one or more control lines configured to enable or disable one of the first voltage regulator and the second voltage regulator.

### RELATED APPLICATIONS

This application claims the benefit of U.S. Provisional Patent Application No. 63/248,702, filed Sep. 27, 2021, the entire content of which is hereby incorporated by reference.

### FIELD

The present disclosure relates to battery operated devices, and more particularly to battery pack powered tools or accessories.

### SUMMARY

Embodiments described herein provide a power management system that includes a battery pack powered tool, one or more battery packs coupled to the battery pack powered tool, a first voltage regulator providing a first output voltage, a second voltage regulator providing a second output voltage, and a trigger configured to receive the first output voltage and the second output voltage. The system also includes one or more control lines configured to enable or disable one of the first voltage regulator and the second voltage regulator.

In some aspects, the one or more battery packs include a first battery pack and a second battery pack.

In some aspects, the system also includes a processing unit configured to control at least one of the one or more control lines to enable or disable the one or more of the first voltage regulator and the second voltage regulator.

In some aspects, the system also includes a switch configured to control at least one of the one or more control lines to enable or disable the one or more of the first voltage regulator and the second voltage regulator.

In some aspects, the switch is configured to control at least one of the one or more control lines to enable or disable each of the first voltage regulator and the second voltage regulator.

In some aspects, the one or more of the first voltage regulator and the second voltage regulator being disabled reduces a quiescent current of the battery pack powered tool to less than about seven micro-Amps.

In some aspects, each of the first voltage regulator and the second voltage regulator being disabled reduces a quiescent current of the battery pack powered tool to less than about seven micro-Amps.

Embodiments described herein provide a battery pack powered tool for managing power consumption. The battery pack powered tool includes one or more battery pack interfaces configured to receive one or more battery packs, a first voltage regulator providing a first output voltage, a second voltage regulator providing a second output voltage, a trigger configured to receive the first output voltage and the second output voltage, and a controller including a processor and a memory. The controller is configured to control, by enabling or disabling one or more of the first voltage regulator and the second voltage regulator using one or more control lines, an amount of power the battery pack powered tool consumes.

In some aspects, the one or more battery packs include a first battery pack and a second battery pack.

In some aspects, the controller includes a processing unit configured to control at least one of the one or more control lines to enable or disable the one or more of the first voltage regulator and the second voltage regulator.

In some aspects, the battery pack powered tool further includes a switch configured to control at least one of the one or more control lines to enable or disable the one or more of the first voltage regulator and the second voltage regulator.

In some aspects, the switch is configured to control at least one of the one or more control lines to enable or disable each of the first voltage regulator and the second voltage regulator.

In some aspects, each of the first voltage regulator and the second voltage regulator being disabled reduces a quiescent current of the battery pack powered tool to less than about seven micro-Amps.

In some aspects, one of the first voltage regulator and the second voltage regulator being disabled reduces a quiescent current of the battery pack powered tool to less than about seven micro-Amps.

Embodiments described herein provide a method for managing power consumption of a battery pack powered tool. The method includes receiving power from one or more battery packs coupled to the battery pack powered tool, and providing the power to at least one of a first voltage regulator and a second voltage regulator of the battery pack powered tool. The first voltage regulator is configured to provide a first output voltage and the second voltage regulator configured to provide a second output voltage. The method also includes providing the first output voltage and the second output voltage to a trigger of the battery pack powered tool, and controlling, with a controller, operation of the battery pack powered tool to enable or disable the at least one of the first voltage regulator and the second voltage regulator using one or more control lines.

In some aspects, the method further includes controlling, with the controller, at least one of the one or more control lines to disable each of the first voltage regulator and the second voltage regulator.

In some aspects, the method further includes determining, with the controller, that a trigger of the of the battery pack powered tool is released, and determining, with the controller, whether the battery pack powered tool is not in use based on a time in an idle state associated with the release of the trigger and a temporal threshold.

In some aspects, the method further includes sending, in response to the time in the idle state of the battery pack powered tool exceeding the temporal threshold, a signal over the one or more control lines to disable the at least one of the first voltage regulator and the second voltage regulator using one or more control lines.

In some aspects, when the at least one of the first voltage regulator and the second voltage regulator is disabled, a quiescent current of the battery pack powered tool is reduced to less than about 7 micro-Amps.

In some aspects, each of the first voltage regulator and the second voltage regulator is disabled, a quiescent current of the battery pack powered tool is reduced to less than about 7 micro-Amps.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the disclosure will become apparent by consideration of the detailed description and accompanying drawings.

### BRIEF DESCRIPTION OF THE DRAWINGS

FIG. 1 is a perspective view of a power tool, such as a handheld blower with optional attachments, according to embodiments disclosed herein.

FIG. 2 illustrates a battery pack for the device of FIG. 1, according to embodiments described herein.

FIG. 3 illustrates a control system for the power tool of FIG. 1, according to embodiments described herein.

FIG. 4 illustrates a voltage control diagram of the power tool of FIG. 1, according to embodiments described herein.

FIG. 5 illustrates a circuit diagram for a trigger switch of the power tool of FIG. 1, according to embodiments described herein.

FIG. 6 illustrates a process for managing power consumption of the power tool of FIG. 1, according to embodiments described herein.

### DETAILED DESCRIPTION

This disclosure relates to a multi-voltage source trigger switch for managing power usage from battery packs coupled to a battery pack powered device, such as a power tool or accessory. The battery pack powered device can be designed to receive one or more battery packs (e.g., two battery packs) which are each managed, for example, with respect to the voltage source trigger switch, for longevity while coupled to the device. It may be beneficial for battery pack powered devices to keep their current consumption to a minimum value to ensure extended battery life of the connected battery packs and to avoid premature battery pack failure due to over-discharge events, in particular, for lithium-ion battery packs. For some devices, it may be preferable to keep standby current consumption to <7 micro-Amps (“uA”) for the battery packs. The standby current consumption can be managed by being able to shut-off, disconnect, or otherwise disable sub circuits or whole groups of sub circuits of the battery pack powered device to lower the quiescent current to <7 uA. By shutting off, disconnecting, or disabling the sub circuits, sub circuits with pull-up resistor values below 1 Megaohm can be used to reduce the overall quiescent current consumption of the circuits when the product is not in use.

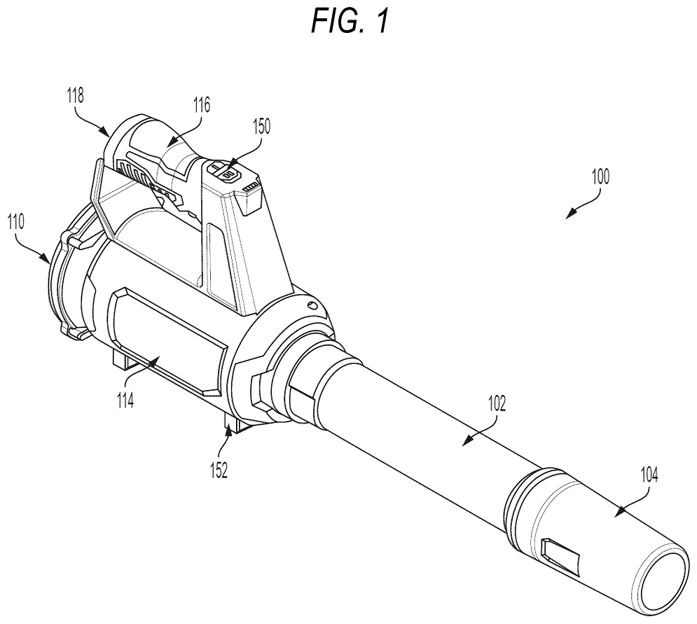

In some embodiments, the present disclosure can be implemented in a battery pack powered power tool or accessory. FIG. 1 provides an example battery pack powered tool 100 being a handheld blower 100 for implementing the features of the present disclosure. Although the present disclosure is discussed with respect to a battery pack powered handheld blower 100, the present disclosure can be implemented using any combination of battery pack powered tools 100 or accessories without departing from the scope of the present disclosure. For example, the present disclosure can be implemented in any combination of cutting tools, drilling tools, lawncare tools, lighting accessories, audio/visual accessories, generators, etc.

FIG. 1 generally illustrates the handheld blower 100 with three attachments including an extension 102 and a nozzle 104. Each of the extension 102 and the nozzle 104 is configured to removably connect to an outlet 108 of the handheld blower 100. The nozzle 104 is also configured to removably connect to the extension 102. The handheld blower 100 further includes an inlet 110 opposite from and upstream of the outlet. In the illustrated embodiment, a grate is disposed over the inlet 110 in order to prevent larger debris from entering the inlet 110. The grate may be a structure creating a series of slits, a screen, a circuitous flow path, or the like. The handheld blower 100 includes an air duct fluidly communicating the inlet 110 with the outlet and extending along a longitudinal axis. The air duct is surrounded at least partially by a housing 114 of the battery pack powered tool 100. In some embodiments, the housing 114 may include two clamshell halves that are joined together with fasteners to surround an air duct. The handheld blower 100 further includes a handle 116. In some embodiments, the handle 116 extends generally parallel to the longitudinal axis.

In some embodiments, the housing 114 and/or the handle 116 may include a battery pack interface or battery pack receiving cavity 118 defined therein. In the illustrated embodiment, the battery pack receiving cavity 118 also extends generally parallel to the longitudinal axis. The battery pack receiving cavity 118 can be configured to receive at least a portion of one or more battery packs. While at least a portion of the battery pack is received in the battery pack receiving cavity 118 in an operational position, at least another portion of the battery pack can be disposed outside of the battery pack receiving cavity 118 (in a direction generally rearwardly of the handle 116 in the illustrated embodiment). The portion of the battery pack outside of the battery pack receiving cavity 118 is disposed radially outwardly from the longitudinal axis at a position that is above the inlet 110. With the battery pack within the battery pack receiving cavity 118, electrical communication can be established between the battery pack and the battery pack powered tool 100. The electrical communication link can be used to provide power from the battery pack to the battery pack powered tool 100, as well as allowing the battery pack powered tool 100 to manage the battery usage.

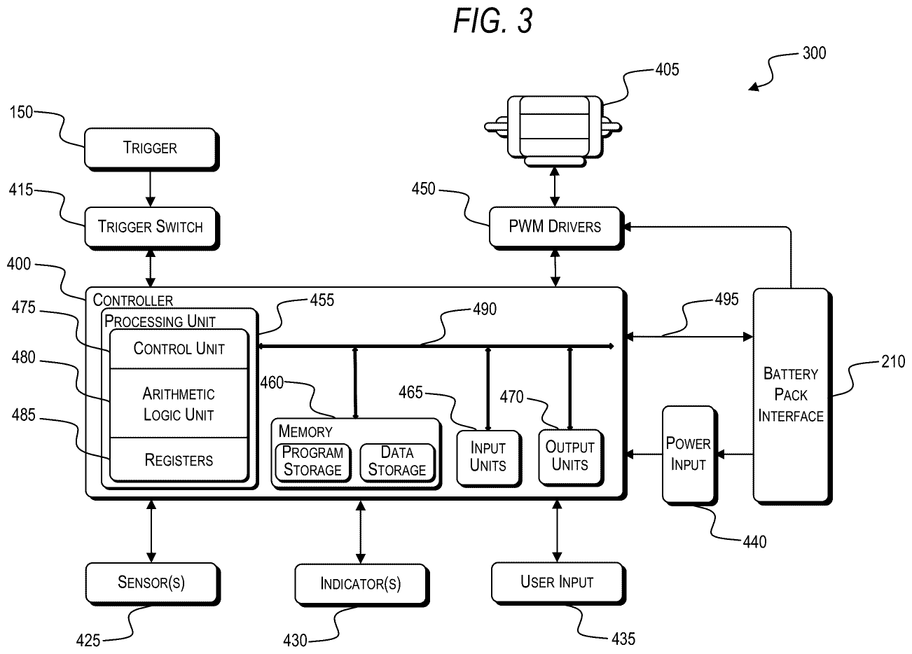

In some embodiments, the battery packs may be any combination of 12-volt, 18-volt, 36-volt, 40V, 80V, etc., battery packs. In some embodiments, the battery pack receiving cavity 118 can be designed to receive two 18-volt battery packs to provide, for example, a combined 36-volts to the battery pack powered tool 100. The battery pack(s) are provided to provide power to the battery pack powered tool 100 and its various components. In some embodiments, the battery pack(s) can provide a power source for the motor (for powering a fan of the blower), a microcontroller (e.g., controller 400 of FIG. 3), pulse width modulation (PWM) drivers 450 (e.g., a FET switching bridge) for the motor, memory 460 (e.g., a solid state drive [SSD]), indicators 430, various sensors 425, and any other combination of electrical components used by the battery pack powered tool 100. In some embodiments, one of the 18-volt battery packs can be designed to power a first sub-group of components while the combination of two 18-volt battery packs can be designed to power a second sub-group of components within the battery pack powered tool 100, as discussed in greater detail below.

The illustrated battery pack powered tool 100 (e.g., handheld blower 100) may include many other features including, for instance, one or more triggers 150 or other controls disposed on or about the handle 116, a plurality of support feet 152 to allow a user to place the handheld blower 100 on a support surface, a plurality of vibration dampening sections (made of, for instance, a polymer material) connecting the air duct to the housing 114, a plurality of nozzle attachments and extension attachments of various shapes, sizes, and lengths, or the like.

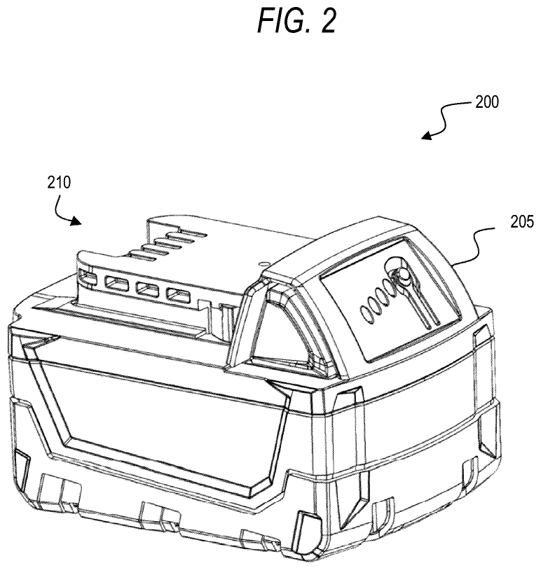

Referring to FIG. 2, a battery pack 200 including a housing 205 and battery pack interface 210 for connecting the battery pack 200 to a device (e.g., a battery pack powered tool 100) is depicted. The discharge of the battery pack 200 can be controlled by any combination of a battery pack controller, a power tool, a battery pack charger, etc., as provided by the present disclosure. The battery pack 200 can be an 18-volt or 36-volt battery pack, although other voltages between 12-volts and 120-volts are contemplated. The battery pack interface 210 includes a combination of mechanical components (e.g., rails, grooves, latches, etc.) and electrical components (e.g., one or more terminals) configured to and operable for interfacing (e.g., mechanically, electrically, and communicatively connecting) the battery pack powered tool 100 with the battery pack 200. For example, power provided by the battery pack 200 to the battery pack powered tool 100 is provided through the battery pack interface 210 to the power input module 440. The power input module 440 (see FIG. 3) includes combinations of active and passive components to regulate or control the power received from the battery pack 200 prior to power being provided to the controller 400. The battery pack interface 210 also supplies power to the PWM drivers 450 to selectively provide power to the motor 405. The battery pack interface 210 also includes, for example, a communication line 495 for provided a communication line or link between the controller 400 and the battery pack 200.

FIG. 3 illustrates an example control system 300 for a battery pack powered device (e.g., a battery pack powered tool 100). The control system 300 includes a controller 400 electrically and/or communicatively connected to a variety of modules or components of the battery pack powered tool 100. For example, the illustrated controller 400 is electrically connected (e.g., directly, indirectly through sub circuits, etc.) to a motor 405, a battery pack interface 210, a trigger switch or switch 415 (connected to a trigger 150), one or more sensors 425 or sensing circuits (e.g., one or more current sensors, one or more speed sensors, one or more Hall Effect sensors, one or more temperature sensors, etc.), one or more indicators 430, a user input module 435, a power input module 440, and PWM drivers 450 (or a field effect transistor [FET] in a bridge configuration module including a plurality of switching FETs). The controller 400 includes combinations of hardware and software that are operable to, among other things, control the operation of the battery pack powered tool 100, monitor the operation of the battery pack powered tool 100, activate the one or more indicators 430 (e.g., light emitting diodes (LEDs), monitor user behavior and actions, application behavior, etc.

In some embodiments, the controller 400 includes a plurality of electrical and electronic components that provide power, operational control, and protection to the components and modules within the controller 400 and/or the battery pack powered tool 100. For example, the controller 400 includes, among other things, a processing unit 455 (e.g., a microprocessor, a microcontroller, an electronic processor, an electronic controller, or another suitable programmable device), a memory 460, input units 465, and output units 470. The processing unit 455 includes, among other things, a control unit 475, an arithmetic logic unit (“ALU”) 480, and a plurality of registers 485 (shown as a group of registers in FIG. 3), and is implemented using a known computer architecture (e.g., a modified Harvard architecture, a von Neumann architecture, etc.). The processing unit 455, the memory 460, the input units 465, and the output units 470, as well as the various modules or circuits connected to the controller 400 are connected by one or more control and/or data buses (e.g., common bus 490). The control and/or data buses are shown generally in FIG. 3 for illustrative purposes. The use of one or more control and/or data buses for the interconnection between and communication among the various modules, circuits, and components would be known to a person skilled in the art in view of the disclosure described herein.

The memory 460 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, SSD, an SD card, or other suitable magnetic, optical, physical, or electronic memory devices. The processing unit 455 is connected to the memory 460 and executes software instructions that are capable of being stored in a RAM of the memory 460 (e.g., during execution), a ROM of the memory 460 (e.g., on a generally permanent basis), or another non-transitory computer readable medium such as another memory or a disc. Software included in the implementation of the battery pack powered tool 100 can be stored in the memory 460 of the controller 400. The software includes, for example, firmware, one or more applications, program data, filters, rules, one or more program modules, and other executable instructions. The controller 400 is configured to retrieve from the memory 460 and execute, among other things, instructions related to the control processes and methods described herein. In other constructions, the controller 400 includes additional, fewer, or different components.

The indicators 430 include one or more visual, audio or haptic feedbacks to provide feedback to a user as of the status of the battery pack powered tool 100 and/or battery pack 200. For example, indicators 430 can include one or more light-emitting diodes (“LEDs”). The indicators 430 can be configured to display conditions of, or information associated with, the battery pack powered tool 100. For example, the indicators 430 are configured to indicate measured electrical characteristics of the battery pack powered tool 100, the status of the battery pack(s) 200, etc. The user input module 435 is operably coupled to the controller 400 to, for example, select a forward mode of operation or a reverse mode of operation, a torque and/or speed setting for the battery pack powered tool 100 (e.g., using torque and/or speed switches), etc. In some embodiments, the user input module 435 includes a combination of digital and analog input or output devices required to achieve a desired level of operation for the battery pack powered tool 100, such as one or more knobs, one or more dials, one or more switches, one or more buttons, one or more touch or pressure sensitive sensors, etc.

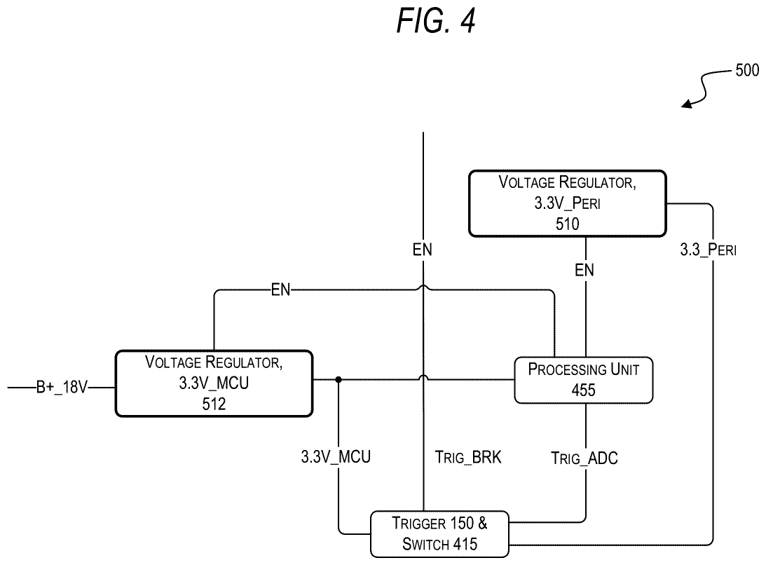

In some embodiments, the controller 400 can include one or more power management systems for controlling power draw from one or more sub-systems of the battery pack powered tool 100, for example, as depicted in FIG. 4. Referring to FIG. 4, an example voltage control diagram 500 is depicted for implementing a power management system of the present disclosure. In some embodiments, the power management system can include the processing unit 455 and the trigger 150/switch 415 that can control enable/activation and disable/deactivation of different sub circuits within the battery pack powered tool 100. The sub circuits can include any combination of sub systems within the battery pack powered tool 100. For example, the sub circuits can include peripherals, motors, sensors, communication lines, or a combination thereof, etc. The processing unit 455 and trigger 150/switch 415 can be coupled to a voltage regulator 512 (e.g., a low dropout [“LDO”] voltage regulator) to receive power from one or more of the battery packs 200. The voltage regulator 512 is used to provide a stable power supply voltage independently of the state of battery charge. For example, as a battery drops from 14.1 V to an almost fully discharged level, the voltage regulator 510 can maintain a constant 3.3 V at the load. In some embodiments, the processing unit 455 and the trigger 150 and/or switch 415 may not require power from each of the connected battery packs 200. For example, the processing unit 455 and the trigger 150/switch 415 may only require power from one of the battery packs 200 coupled to the battery pack powered tool 100.

In some embodiments, a combination of the processing unit 455 and the trigger 150 and/or switch 415 can control activation/deactivation of the sub circuits of the battery pack powered tool 100. For example, the sub circuits can be disabled by sending a deactivation or disable signal to a voltage regulator 510 or other switch/regulator providing power to those sub circuits. In some embodiments, the processing unit 455 can be coupled to the control lines for another voltage regulator 510 while the trigger 150 and/or switch 415 can be coupled to one or more other sub circuits. The trigger 150/switch 415 can also be coupled to the processing unit 455 and the components for the battery pack powered tool 100. The control lines between the processing unit 455 and the trigger and/or switch 415 can be provided to control when the various control lines to the trigger 150/switch 415 are activated/deactivated. The enable lines can be used to disable either of the sub circuits individually or all circuits as a group. In some embodiments, the trigger 150/switch 415 include multiple (e.g., two or more) input power lines. One input power line comes from the voltage regulator 510. A second input power line comes from the voltage regulator 512.

By disabling or deactivating one or some of the sub circuits or the whole battery pack powered tool 100, a power saving mode is implemented that lowers the quiescent current of the battery pack powered tool 100 to below a threshold value (e.g., less than 7 uA). Specifically, being able to shut-off/disconnect/disable one of the plurality of sub circuits or whole groups of sub circuits, enables sub circuits with pull-up resistor values below 1 Megohm to be used that reduce the overall quiescent current consumption of the circuits when the product is not in use.

In some embodiments, power from one or more of multiple battery packs 200 can be provided to power a plurality of sub circuits. The power management system can be designed such that a combination of battery packs 200 can be used for powering the processing unit 455 and the trigger 150 and/or switch 415, and the various other sub circuits of the battery pack powered tool 100. For example, a combination of two 18V battery packs 200 can be used in combination and/or individually to power the processing unit 455 and the trigger 150 and/or switch 415 and/or different sub circuits.

In some embodiments, the processing unit 455 and the trigger 150 and/or switch 415 can be coupled to control lines for controlling the enabling/disabling of the switches and/or voltage regulators providing power to the different sub circuits. The switches and/or voltage regulators can each include an enable pin for turning the control of the switches and/or regulators on or off. The enable pins can be coupled to control lines connected to a combination of the processing unit 455, the trigger 150, and/or the switch 415. The processing unit 455, the trigger 150, and/or switch 415 can provide enable (e.g., wake) and/or disable (e.g., sleep) signals depending on how the power management system is configured.

In some embodiments, the processing unit 455 can be coupled to control lines for the voltage regulator 510 while the trigger 150 and/or switch 415 can be coupled to a control line for a high side switch (e.g., in a main power line of the battery pack powered tool 100). Depending on operation of the battery pack powered tool 100, the different control lines can be activated/deactivated to control load from the respective sub circuits. The control lines may be analog, digital, and/or any other communication type and control lines that may, but are not limited to enable or disable the circuits that source and/or control the supply voltage to multiple cascaded sub circuits at once or individual sub circuit groups individually. For example, a first plurality of sub circuits and a second plurality of sub circuits can be arranged in a cascaded manner in which deactivation of a switch (e.g., a switched mode power supply) will result in the deactivation of both the first and second plurality of sub circuits. Using the control lines, improvement to the longevity and operation of the battery packs 200 connected to the battery pack powered tool 100 can be achieved because they lower the current consumption of the battery pack(s) 200 by deactivating circuits when they are not in use. Additionally, the longevity and operation of the battery packs 200 can be improved through a combination of power sequencing (e.g., selectively turning on and off sub circuits that power the trigger 150/switch 415) and reduced quiescent current to extend battery shelf life.

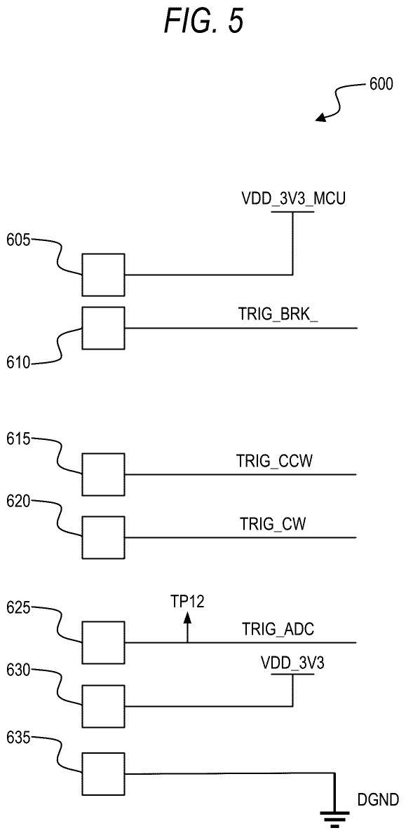

Referring to FIG. 5, in some embodiments, a sequenced voltage source trigger switch can be implemented to minimize current consumption of the trigger. FIG. 5 depicts an example trigger switch circuit 600, for example, for the switch 415. The trigger switch circuit 600 can include a first trigger pin 605 connected to a first supply voltage source (e.g., VDD_3V3_MCU from the voltage regulator 510). The trigger switch circuit 600 can include a second trigger pin 610 for outputting an enable signal (e.g., indicating that the trigger 150 has been activated). The trigger switch circuit 600 can include a third trigger pin 615 and a fourth trigger pin 620 for controlling, for example, a rotational direction of a motor (e.g., clockwise or counter-clockwise). The trigger switch circuit 600 can include a fifth trigger pin 625 providing a signal related to an amount of actuation of the trigger 150 (i.e., amount of trigger pull). The trigger switch circuit 600 can include a sixth trigger pin 630 connected to a second supply voltage source (e.g., VDD_3V3 from a voltage regulator 512). Finally, the trigger switch circuit 600 can include a ground pin 635.

Each of the first and second supply voltages could be configured to be turned on or off at any time and/or can be permanently active. The first and second supply voltages may also be individually controlled and/or controlled based on an active/inactive state of the other supply voltages. For example, if VDD_3V3 at pin 605 is turned off or otherwise disconnected/disabled, the supply voltage for VDD_3V3_MCU at pin 630 may be turned on or otherwise connected/enabled. This can include switching voltage supplies between the two sources or the VDD_3V3 at pin 630 may provide its supply voltage permanently, while the VDD_3V3_MCU at pin 605 is selectively provided based on other factors or conditions of the battery pack powered tool 100 (e.g., whether the trigger 150 is pulled, an elapsed idle time reaching a threshold value, etc.). As such, for a trigger switch circuit 600 that includes two voltage input pins, power to one or both of those voltage input pins can be selectively disabled to reduce the quiescent current of the battery pack powered tool 100. In some embodiments, the first and second supply voltages (e.g., VDD_3V3 at pin 630 and VDD_3V3_MCU at pin 605) can be sourced from the same battery pack supply or separate battery pack supplies. For example, the first supply voltage (e.g., VDD_3V3 at pin 630) can be sourced from one battery pack while the second supply voltage (e.g., VDD_3V3_MCU at pin 605) can be sourced from a second battery pack.

The voltage supplies at pin 605 and pin 630 do not need to be provided specifically from the voltage regulators 510, 512. Instead, the voltages can be provided by, for example, the processing unit 455, the controller 400, a logic circuit, or another circuit that outputs voltages. The supply or sourcing signal may be continuous or discontinuous in the signal time domain. For example, the supply signal may be a DC signal, an AC signal, or in another form that is modulated or encoded. This contrasts with previous circuits which have utilized permanently connected supply voltages that resulted in higher quiescent current when the products are not in use.

In operation, the battery pack powered tool 100 can receive one or more battery pack(s) 200, for example, in the battery pack receiving cavity 118. The one or more battery pack(s) 200 can provide power to the battery pack powered tool 100 and its various components. The battery pack(s) 200 can be in communication with the one or more switches and/or voltage regulators which provide power to each of the sub circuits of the battery pack powered tool 100. For example, the battery pack(s) 200 can provide power to the voltage regulator 510, 512 to power the processing unit 455 and trigger 150/switch 415. The power can be provided on demand based on activation of the battery pack powered tool 100, for example, actuation of the trigger 150.

To prevent the inserted battery pack(s) 200 from being depleted/damaged while connected to the battery pack powered tool 100, the power management system described herein can be implemented to minimize the current consumption of the battery pack powered tool 100. The power management system of the present disclosure can reduce current consumption by implementing the circuit designs discussed with respect to FIGS. 4 and 5. When the battery pack powered tool 100 is not in use (e.g., trigger 150 released, an elapsed idle time has been reached, etc.), a combination of the processing unit 455 and trigger 150/switch 415 can send disable signals over one or more control lines to disable respective sub circuits of the battery pack powered tool 100. Similarly, when the battery pack powered tool 100 is enabled, a combination of the processing unit 455 and trigger 150/switch 415 can send enable signals over one or more control lines to enable the respective sub circuits of the battery pack powered tool 100.

As depicted in FIG. 4, the processing unit 455 can be coupled to control lines for the voltage regulator 510, 512 and other sub circuits. The trigger 150/switch 415 can be coupled to control lines for some sub circuits and a trigger line to the processing unit 455. Activation of the trigger 150/switch 415 can cause a signal to be sent to the processing unit 455. In response to receiving a trigger signal, the processing unit 455 can send enable signals to the voltage regulator 510, 512 and/or other sub circuits to activate those circuits.

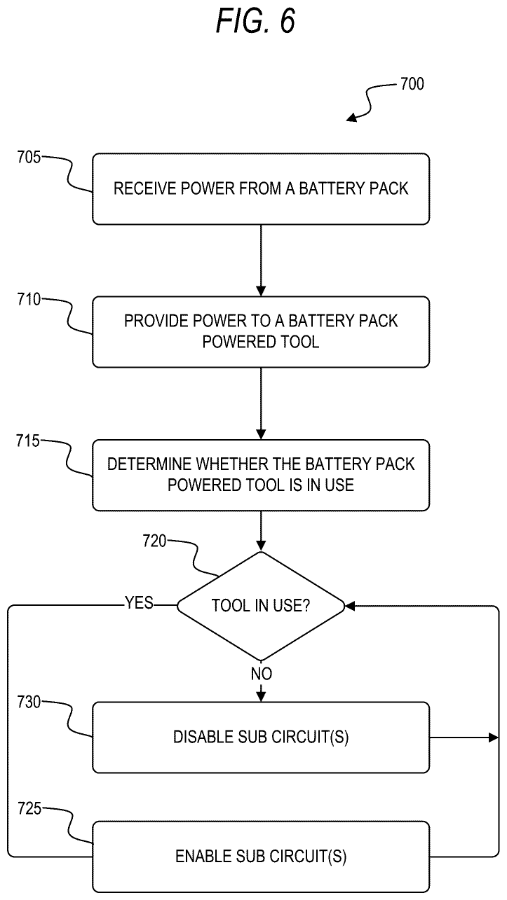

FIG. 6 illustrates a method 700 executed by the controller 400 of the battery pack powered tool 100. The controller 400 receives a voltage signal from the battery pack 200 and determines that a battery pack 200 is coupled to the battery pack powered tool 100 (STEP 705). The controller 400 provides power to a variety of modules or components of the battery pack powered tool 100 (STEP 710). The controller 400 determines whether the battery pack powered tool 100 is in use (STEP 715). For example, when the controller 400 receives a signal from the trigger 150, the controller 400 determines that the trigger 150 is being pulled and that the battery pack powered tool 100 is in use. If, at STEP 720, the battery pack powered tool 100 is in use, one or more sub circuits of the battery pack powered tool can be enabled (e.g., voltage regulator 510, 512) (STEP 725). When, for example, the controller 400 stops receiving a signal from the trigger 150, the controller 400 determines that the trigger 150 is released and the battery pack powered tool 100 is not in use. When the battery pack powered tool 100 is not in use, the one or more sub circuits of the battery pack powered tool can be disabled (STEP 730). In some embodiments, after a defined time-period (e.g., temporal threshold) has elapsed without receiving a signal from the trigger 150, the controller 400 determines that the battery pack powered tool 100 is not in use.

Although the disclosure has been described in detail with reference to certain preferred embodiments, variations and modifications exist within the scope and spirit of one or more independent aspects of the disclosure as described.

What is claimed is:

1. A power management system comprising:
a battery pack powered tool;
one or more battery packs coupled to the battery pack powered tool;
a first voltage regulator providing a first output voltage;
a second voltage regulator providing a second output voltage;
a trigger configured to receive the first output voltage and the second output voltage; and
one or more control lines configured to enable or disable one or more of the first voltage regulator and the second voltage regulator.

2. The system of claim 1, wherein the one or more battery packs include a first battery pack and a second battery pack.

3. The system of claim 1, further comprising:
a processing unit configured to control at least one of the one or more control lines to enable or disable the one or more of the first voltage regulator and the second voltage regulator.

4. The system of claim 1, further comprising:
a switch configured to control at least one of the one or more control lines to enable or disable the one or more of the first voltage regulator and the second voltage regulator.

5. The system of claim 4, wherein the switch is configured to control at least one of the one or more control lines to enable or disable each of the first voltage regulator and the second voltage regulator.

6. The system of claim 1, wherein the one or more of the first voltage regulator and the second voltage regulator being disabled reduces a quiescent current of the battery pack powered tool to less than about seven micro-Amps.

7. The system of claim 6, wherein each of the first voltage regulator and the second voltage regulator being disabled reduces the quiescent current of the battery pack powered tool to less than about seven micro-Amps.

8. A battery pack powered tool for managing power consumption, the battery pack powered tool comprising:
one or more battery pack interfaces configured to receive one or more battery packs;
a first voltage regulator providing a first output voltage;
a second voltage regulator providing a second output voltage;
a trigger configured to receive the first output voltage and the second output voltage; and
a controller including a processor and a memory, the controller configured to:
control, by enabling or disabling one or more of the first voltage regulator and the second voltage regulator using one or more control lines, an amount of power consumed by the battery pack powered tool.

9. The battery pack powered tool of claim 8, wherein the one or more battery packs include a first battery pack and a second battery pack.

10. The battery pack powered tool of claim 8, wherein the controller includes a processing unit configured to control at least one of the one or more control lines to enable or disable the one or more of the first voltage regulator and the second voltage regulator.

11. The battery pack powered tool of claim 8, further comprising:
a switch configured to control at least one of the one or more control lines to enable or disable the one or more of the first voltage regulator and the second voltage regulator.

12. The battery pack powered tool of claim 11, wherein the switch is configured to control at least one of the one or more control lines to enable or disable each of the first voltage regulator and the second voltage regulator.

13. The battery pack powered tool of claim 8, wherein each of the first voltage regulator and the second voltage regulator being disabled reduces a quiescent current of the battery pack powered tool to less than about seven micro-Amps.

14. The battery pack powered tool of claim 8, wherein one of the first voltage regulator and the second voltage regulator being disabled reduces a quiescent current of the battery pack powered tool to less than about seven micro-Amps.

15. A method for managing power consumption of a battery pack powered tool, the method comprising:
receiving power from one or more battery packs coupled to the battery pack powered tool;
providing the power to at least one of a first voltage regulator and a second voltage regulator of the battery pack powered tool, the first voltage regulator configured to provide a first output voltage and the second voltage regulator configured to provide a second output voltage;
providing the first output voltage and the second output voltage to a trigger of the battery pack powered tool; and
controlling, with a controller, operation of the battery pack powered tool to enable or disable the at least one of the first voltage regulator and the second voltage regulator using one or more control lines.

16. The method of claim 15, further comprising:
controlling, with the controller, at least one of the one or more control lines to disable each of the first voltage regulator and the second voltage regulator.

17. The method of claim 15, further comprising:
determining, with the controller, that the trigger of the of the battery pack powered tool is released; and
determining, with the controller, whether the battery pack powered tool is not in use based on a time in an idle state associated with a release of the trigger and a temporal threshold.

18. The method of claim 17, further comprising:
sending, in response to the time in the idle state of the battery pack powered tool exceeding the temporal threshold, a signal over the one or more control lines to disable the at least one of the first voltage regulator and the second voltage regulator using the one or more control lines.

19. The method of claim 15, wherein, when the at least one of the first voltage regulator and the second voltage regulator is disabled, a quiescent current of the battery pack powered tool is reduced to less than about 7 micro-Amps.

20. The method of claim 15, wherein, each of the first voltage regulator and the second voltage regulator is disabled, a quiescent current of the battery pack powered tool is reduced to less than about 7 micro-Amps.
